(19) United States
(12) Patent Application Publication
(10) Pub. No.: US 2005/0176408 A1
(43) Pub. Date: Aug. 11, 2005

(54) Method and apparatus for providing for wireless commissioning of network elements

(76) Inventor: Robert C. Stein, Coopersburg, PA (US)

Correspondence Address: Motorola, Inc., 101 Tournament Drive, Horsham, PA, 19044, US

(21) Appl. No.: 10/775,902

(22) Filed: Feb. 10, 2004

(51) Int. Cl. H04M 1/66

(52) U.S. Cl. 455/411

(57) ABSTRACT

The present invention is a method and apparatus for providing for wireless commissioning for a network element in a communications system 200. A wireless device 222, such as a wireless telephone, initiates a commissioning session with network element 202. In response, the network element 202 verifies security mechanisms with the wireless device 222. The network element 202 then receives commissioning data from the wireless device 222, and utilizes the commissioning data to obtain service provisioning information from an element management system 214 in the communications network 208 via a network interface 204.

### FIELD OF THE INVENTION

The present invention relates to the field of communications networks, and more particularly, to an apparatus and method for providing wireless commissioning of network elements in a communications network.

### BACKGROUND OF THE INVENTION

In communications networks, network elements often require a minimal amount of initial configuration to connect successfully to the communications network. Sometimes referred to as “commissioning,” the network elements make an initial connection to the network to retrieve their configuration and service provisioning data. These network elements may comprise any device in a communications network that requires a commissioning process to operate in a communications network, including but not limited to, a set-top device, a hub device, an enterprise access device, or a residential fiber terminal. The minimal amount of initial configuration in the network element is often referred to as “commissioning data.” This commissioning data may comprise any data necessary for commissioning the network element, including an Internet protocol (IP) address, an IP subnet mask, an IP default gateway name, or a subscriber identifier.

Presently, as illustrated in prior art communications network 100 in FIG. 1, commissioning data is entered into a network element 102 via a local craft interface 106 coupled to serial port 120. This local craft interface 106 is typically an RS232 serial or Ethernet interface 106. Furthermore, serial port 120 is located on the body of the network element 102.

A technician connects to the serial port 120 on network element 102 via a laptop computer 118. This laptop computer 118 comprises a terminal emulation program 114 in memory 112. Via the terminal emulation program 114, the technician uses a generic character-oriented command line interface (CLI) and command line interface CLI program 116 executing in the network element 102 to log into the network element 102 processing unit 110. This login is accomplished utilizing factory installed security parameters, such as a username and password. Once access to the network element 102 is achieved, the technician enters or sets the commissioning data for the network element 102. After the commissioning data has been set, the network element 102 communicates with an element management system 122 through the network 108 to obtain the subscriber's service provisioning data.

While this laptop approach 100 is commonly used today, the laptop computer approach 100 has several undesirable drawbacks. The first drawback is the preparation by the technician required prior to the commissioning process. When an Ethernet interface is used, the technician's laptop computer 118 must be configured correctly to communicate with the network element 102 via factory default IP settings. Additionally, the technician typically must establish a telnet session via the laptop computer 118 to connect to the communications network 108. Both of these steps require manpower and additional steps, adding to the total time and resources consumed by the overall commissioning process.

The second drawback with the present approach is the mere involvement of the laptop computer 118 in the commissioning process. Because each company in the communications industry must have a technician to commission new network elements, each of these technicians must be provided with a laptop computer. Because laptop computers may range from several hundred to over a thousand dollars, providing a laptop computer to each technician performing the commissioning process represents a significant expense to the company.

The third drawback with the present invention concerns the serial port 120, which has many disadvantages in itself. The various technical parts required to construct and provide the serial port 120 significantly raise the overall cost of the network element 102. Because the high cost of these parts, the costs are passed on to the consumer in the form of higher prices for the network elements. In turn, this results in loss of competitive advantage in the marketplace for the network element manufacturer and provider. Furthermore, the presence of the serial port 120 presents an obvious potential for malicious activity by a hacker attempting access into the system. Hackers potentially could easily connect to the serial port 120, because it is typically visible in plain view. Such fraudulent access would wreak havoc on the communications network, costing the company large sums of money as well as extinguished customer satisfaction.

Therefore, there is a need in the art for an apparatus and method for commissioning network elements in such a way that requires minimal preparation by the technician beforehand. There is also a need in the art for an apparatus and method for commissioning network elements without requiring the technician to possess a laptop computer. Another need in the art is for an apparatus and method for commissioning network elements without requiring the network element to comprise a serial port. Furthermore, there is a need in the art for an apparatus and method for commissioning network elements that minimizes the threat of fraudulent access by unauthorized persons.

### SUMMARY OF THE INVENTION

The present invention overcomes the aforementioned and other deficiencies in the prior art by providing for wireless commissioning of network elements in a communications network. To begin the commissioning process, the wireless device sends a commissioning session request to the network element via a wireless interface, such as BLUETOOTH. The network element establishes a commissioning session with the wireless device and verifies security mechanisms with the wireless device. The network element then receives commissioning data from the wireless device, which is utilized to complete the commissioning process. The service provisioning information, which is information relating to the particular characteristics of service provided to the network element, is communicated separately by the network element to the communications network via a network interface.

### BRIEF DESCRIPTION OF THE DRAWINGS

For a fuller understanding of the present invention, reference is made to the following description taken in connection with the accompanying drawings, in which:

FIG. 1 is a block diagram illustrating the prior art laptop approach to commissioning a network element in a communications network.

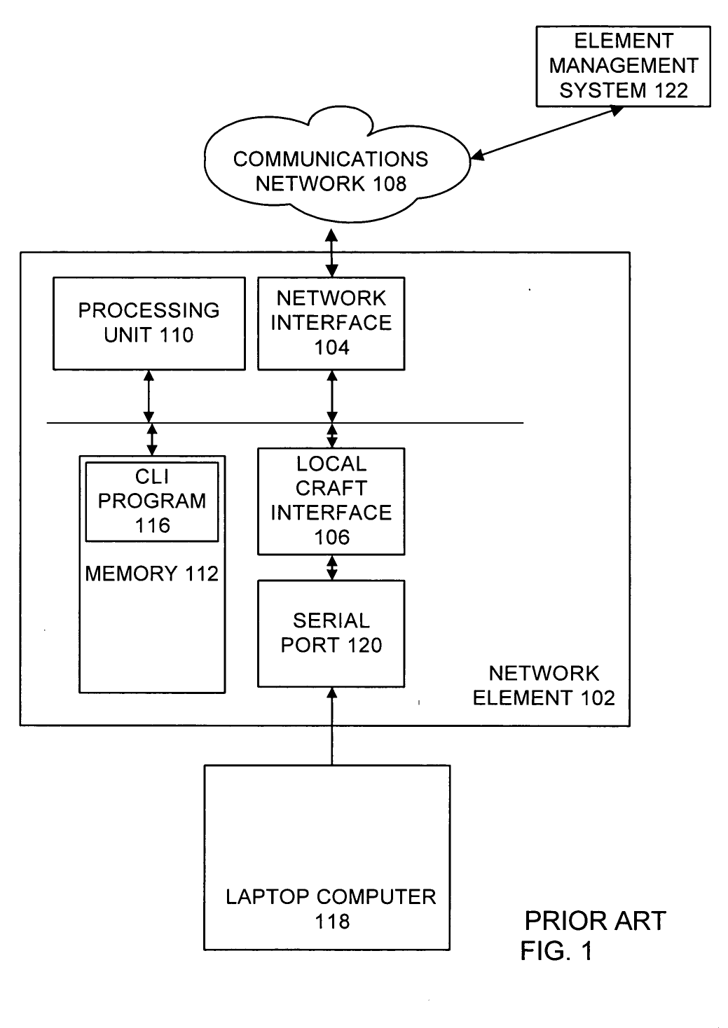

FIG. 2 is a block diagram illustrating a system in accordance with an exemplary embodiment of the present invention.

FIG. 3 is a flow diagram illustrating the commissioning process in accordance with an embodiment of the present invention from the perspective of the wireless device.

FIG. 4 is a flow diagram further illustrating the commissioning process in accordance with the present invention from the perspective of the network element.

### DETAILED DESCRIPTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing a preferred embodiment of the invention.

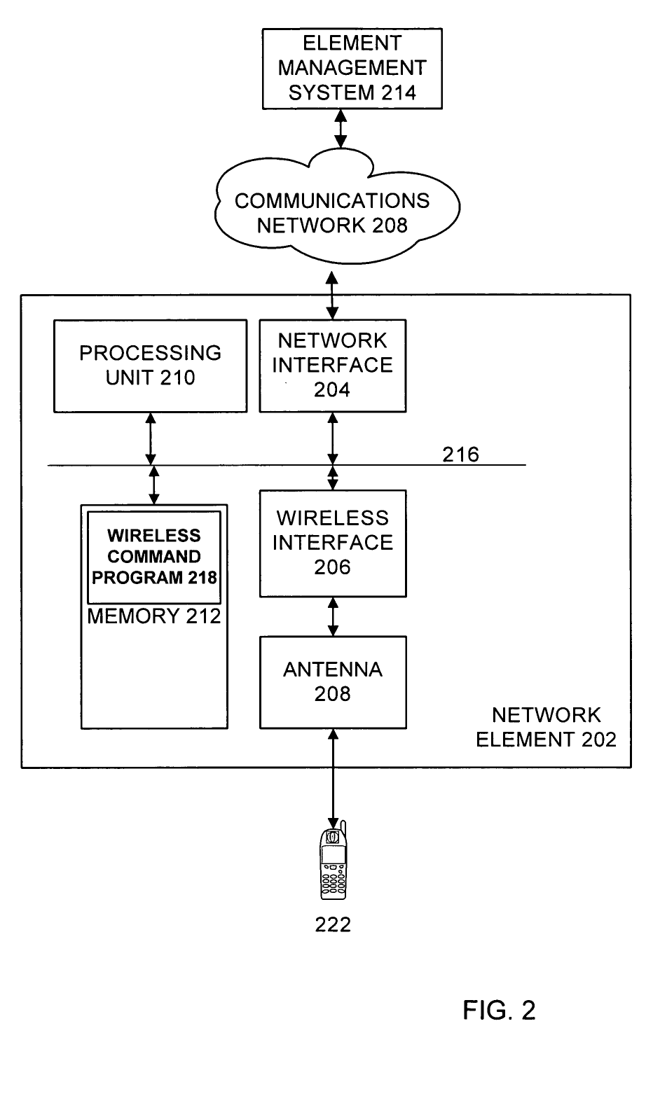

FIG. 2 is a block diagram illustrating a system in accordance with an exemplary embodiment of the present invention. System 200 comprises network element 202, which may comprise any device coupled to a communications network 208 that require a commissioning process to operate in a communications network. Exemplary devices which may comprise a network element 202 include, but are not limited to, a set-top device, a hub device, an enterprise access device, or a residential fiber terminal. Element management system 214 communicates with network element 202 via the communications network 208.

Network element 202 also comprises a network interface 204 for communicating with network 208. Memory 212, which may comprise volatile or non-volatile memory, may comprise a program module (not shown) comprising instructions for processing unit 210 and specifically comprising a wireless command program 218 for accepting commissioning data from a wireless device 222. The components within network element 202 communicate via a system bus 216.

Instead of comprising the serial port 120 and local craft interface 106, as in network element 102, network element 202 comprises a wireless interface 206 coupled to an antenna 208. Wireless device 222, which may comprise but is not limited to a mobile telephone, comprises any device capable of communicating data to another device via a wireless protocol. Wireless device 222 communicates via a wireless protocol with network element 202 via antenna 208. The wireless protocol may comprise any of the wireless protocols for communicating between two electronic devices, including but not limited to, Bluetooth or IEEE 802.11b (WiFi) technology.

It should be noted that any of the wireless protocols utilized in the industry would be suitable for enabling communications between the wireless device 222 and the network element 202. Furthermore, it should be noted that the presence of wireless interface 206 and antenna 208, instead of local craft serial port 120 and local craft interface 106 which are typically much more expensive parts, results in a more inexpensive network element 202 than the network element 102 in system 100.

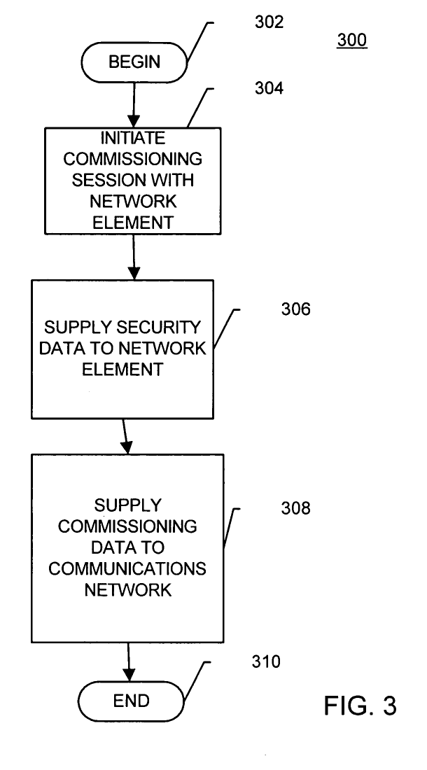

FIG. 3 is a flow diagram illustrating the commissioning process in accordance with an embodiment of the present invention from the perspective of the wireless device 222. Method 300 begins at step 302 and proceeds to the initiation of a commissioning session with network element 202 at step 304. The wireless device 222 may initiate a commissioning session with network element 202 via a wireless protocol. This initiation may take the form of the wireless device 222 generating a commissioning session request directed to the network element 202, which is received by the wireless interface 206 of network element 202 via antenna 208.

At step 306, the wireless device 222 supplies security data to network element 202. This security data may comprise any data necessary or useful in recognizing wireless device 222 as an authorized device to communicate with the network element 202, and to initiate the commissioning process with network element 202. Such security data may include, but is not limited to, a username-password combination or an alpha-numeric passcode. To help deter unauthorized access to the network element 202 or the network 208, the wireless device only can communicate with the network element 202 when authenticated.

At step 308, the wireless device 222 supplies commissioning data to network element 202. The commissioning data may comprise any data needed by network element 202 to complete configuration in order to communicate effectively with network 208. This commissioning data may include, but is not limited to, the IP address of network element 202, the IP subnet mask of network element 202, an IP default gateway name, or a subscriber identifier. This commissioning data may be entered into the wireless device 222 in any effective manner, including actuation of one or more buttons on a keyboard coupled to the wireless device 222.

Method 300 terminates at step 310 once the commissioning process for network element 202 to network 208 is completed. Thus, at the conclusion of method 300, network element 202 is configured properly to communicate with the element management system 214 in system 200 to obtain the subscriber's service provisioning data.

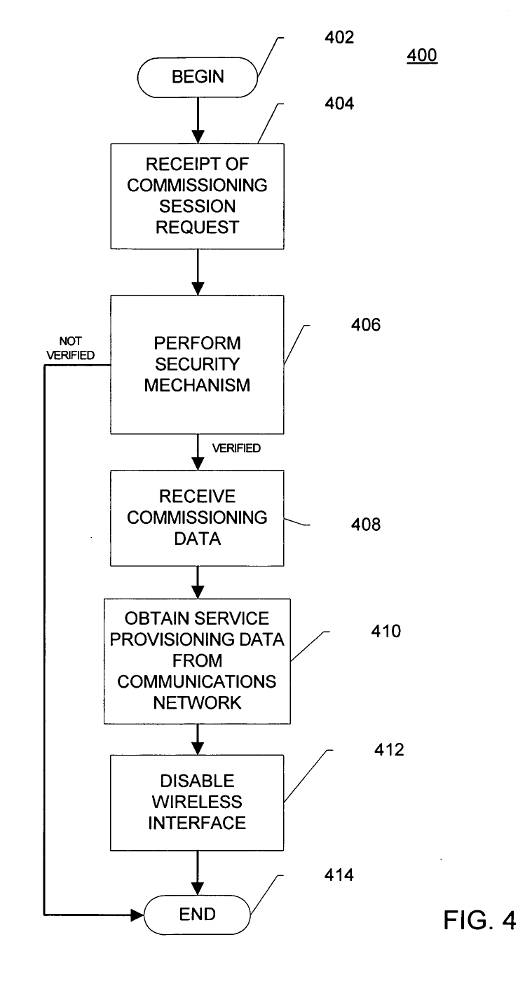

FIG. 4 is a flow diagram further illustrating the commissioning process in accordance with the present invention from the perspective of the network element 202. Method 400 begins at step 402 and proceeds to the receipt of a commissioning request from the wireless device 222 at step 404. The commissioning session request may be communicated to the network element 202 from wireless device 222 via a wireless protocol. This initiation may take the form of the wireless device 222 communicating a commissioning session request with the network element 202, which is received by the wireless interface 206 of network element 202 via antenna 208.

At step 406, security mechanisms are performed with wireless device 222. These security mechanisms may include any security mechanisms in the art for preserving security in wireless communications, including but not limited to, Wi-Fi Protected Access (WPA). These security mechanisms are performed by utilizing security data supplied by the wireless device 222 at step 306 of method 300. This security data may include, but is not limited to, a username-password combination or an alpha-numeric passcode.

If the security mechanisms are not verified, method 400 terminates at step 412. Otherwise, at step 408, the network element 202 receives the commissioning data from wireless device 222. This commissioning data may comprise an IP address, an IP subnet mask, an IP default gateway name, a subscriber identifier, or any other information necessary to effectuate the commissioning process for network element 202. The commissioning data is received from the wireless device from the wireless interface 206 via antenna 208. Once received, network element 202 may store this commissioning data in memory 212.

At step 410, the network element 202 uses the commissioning data to communicate with the element management system 214 via the communications network 208 to obtain the subscriber's the service provisioning. The service provisioning data is not communicated from wireless device 222 to network element 202, as may be done in the prior art.

This service provisioning data may include any information necessary or helpful in allocating service to network element 202, such as service package type, billing information, or other service information. Step 410 may also involve the communications network 208 returning information to the network element 202 to be communicated to the wireless device 222, or to be stored within network element 202.

Step 412 describes an optional or system operator controlled procedure for Method 400. To further enhance the security of the network element 202 and network 208, the element management system may complete the commissioning and service provisioning process by disabling the wireless interface 206, preventing unauthorized access to the network element 202 by even a determined hacker. Method 400 then concludes at step 414 at the conclusion of the commissioning process.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable carrier” for purposes of embodiments of the present invention may be any medium or transmission that can contain, store, communicate, propagate, or transport the program for use by or in connection with the instruction execution system, apparatus, system or device. The computer readable carrier can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, an and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in the following claims and/or to the particular embodiment disclosed as the best mode contemplated for carrying out this invention, but that the invention will include any and all embodiments and equivalents falling within the scope of the appended claims.

1. A method for receiving commissioning data for connecting to a communications network via a wireless device, said method comprising the steps of:
establishing a commissioning session with the wireless device;
verifying security mechanisms with the wireless device; and,
communicating commissioning data to a communications network via the wireless device.

2. The method of claim 1, further comprising the step of communicating service provisioning data to the communications network via a network interface.

3. The method of claim 1, wherein said establishing a commissioning session with the wireless device step comprises establishing a Bluetooth session with the wireless device.

4. The method of claim 1, wherein said communicating commissioning data to a communications network via the wireless device comprises communicating an Internet protocol address for the network element.

5. A method for commissioning a network element in a communications network via a wireless interface, said method comprising the steps of:
initiating a commissioning session with the network element via the wireless interface;
verifying security mechanisms via the wireless interface; and
communicating the commissioning data to the communications network via the wireless device.

6. The method of claim 5, wherein initiating a commissioning session with the network element via the wireless interface comprises generating a commissioning request for the network element.

7. The method of claim 5, wherein initiating a commissioning session with the network element via the wireless interface comprises initiating a commissioning session with the network element via Bluetooth technology.

8. The method of claim 6, wherein communicating the commissioning data to the communications network via the wireless interface comprises communicating an Internet protocol address for the network element to the communications network.

9. An apparatus comprising commissioning data and service provisioning data for connecting to a communications network, said apparatus comprising:
a wireless interface for receiving commissioning data from a wireless device;
a network interface coupled to the communications network; and
wherein said apparatus establishes a commissioning session with the wireless device; verifies security mechanisms with the wireless device; and communicates commissioning data to the communications network via the wireless device.

10. The apparatus of claim 9, wherein said apparatus communicates service provisioning data to the communications network via the network interface.

11. The apparatus of claim 9, wherein said wireless interface comprises an antenna.

12. The apparatus of claim 9, wherein said wireless interface comprises a BLUETOOTH wireless interface.

13. The apparatus of claim 9, wherein said apparatus further comprises an external body and said wireless interface is removable from said external body.

14. The apparatus of claim 13, wherein said memory is removable from said external body.

15. An apparatus which may be commissioned for connecting to a communications network via a wireless craft interface device, said apparatus comprising:
a wireless transmitter for coupling with a wireless interface on the network element; and,
a connection to a communications network;
wherein said apparatus initiates a commissioning session with the network element via the wireless interface; verifies security mechanisms via the network element via the wireless interface; and communicates the commissioning data to the communications network via the wireless interface.

16. The apparatus of claim 15, wherein said wireless transmitter is a BLUETOOTH transmitter.

17. The apparatus of claim 15, wherein said apparatus is a wireless telephone.

18. The apparatus of claim 15, wherein said apparatus is a personal data assistant.

19. A computer-readable carrier including computer program instructions that instruct a computer to perform the steps of:
establish a commissioning session with a wireless device;
verify security mechanisms with the wireless device;
receive commissioning data from the wireless device;
communicate service provisioning data to the communications network.

20. The computer readable medium of claim 19, wherein said verifying security mechanisms with the wireless device step may comprise the step of receiving a commissioning session request via the wireless device.

21. The computer readable medium of claim 19, wherein receiving commissioning data from the wireless device comprises receiving an internet protocol address for the network element.

22. The computer readable medium of claim 19, wherein communicating service provisioning data to the communications network comprises communicating commissioning data to the communications network.

23. A commissioning module for commissioning a network element in a communications network via a wireless device, said commissioning module comprising:
a network element, said network element comprising a wireless interface and a network interface;
a wireless device, said wireless device comprising a wireless transmitter for coupling with the wireless interface on the network element;
wherein said commissioning module performs the steps of establishing a commissioning session with the wireless device, verifying security mechanisms with the wireless device, and, communicating commissioning data to the communications network via the wireless interface.

24. The commissioning module of claim 23, wherein said commissioning module further performs the steps of communicating service provisioning data to the communications network via the network interface.

25. The commissioning module of claim 24, wherein said apparatus generates said service provisioning data.

26. The commissioning module of claim 24, wherein said apparatus receives said service provisioning data from said wireless interface.

27. The commissioning module of claim 23, wherein said wireless transceiver comprises a BLUETOOTH transceiver.
